(19) United States
(12) Patent Application Publication
(10) Pub. No.: US 2010/0111641 A1
(43) Pub. Date: May 6, 2010

(54) SLOTTED SCREW

(76) Inventor: Hanspeter Zoller, La Tour-De-Peilz (CH)

Correspondence Address: BIRCH STEWART KOLASCH & BIRCH, PO BOX 747, FALLS CHURCH, VA, 22040-0747, US

(21) Appl. No.: 12/514,974

(22) PCT Filed: Nov. 13, 2007
(86) PCT No.: PCT/CH2007/000566

§ 371 Date: Dec. 16, 2009

(30) Foreign Application Priority Data
Nov. 15, 2006 (CH) 1832/06
Jul. 6, 2007 (CH) 1093/07

(51) Int. Cl. F16B 23/00; B25B 15/00; B25B 23/12

(52) U.S. Cl. 411/403; 81/460; 81/451

(57) ABSTRACT

A slotted screw has slot surfaces (9) on the screw head, wherein the slot surfaces are vertical or approximately vertical and are arranged parallel to one another or approximately parallel to one another. The slotted screw, furthermore, has slot seating surfaces (10), inclined outwards at an angle within the range of 0° to 20°, and a half-round and deepened centring surface (12) with its deepest point (13), said centring surface (12) being located in the centre by rounded-off point surfaces (11). The slotted screw is designed in such a way that a tip, to be received, for manual screwdrivers/bits and for screwdriving apparatuses, by means of its screwdriving surfaces (1), which are vertical or approximately vertical and which are arranged parallel to one another or approximately parallel to one another, and by means of the corresponding slot seating surfaces (3) and a half-round and raised centring surface (5) with its highest point (6), which centring surface (5) is located in the centre by rounded-off corner surfaces (4), can ensure the centring of the screwdriver/bit tips in the slotted screw for insertion and for the start of and during the screwdriving operation. The slotted screw may be designed as a diametrically slotted screw or as a triple radially slotted screw.

### TECHNICAL FIELD

The invention relates to diametrically slotted screws and 3R slotted screws (triple radially slotted screws) and their screwdriver tips/bits.

### PRIOR ART

Since the introduction of the manufacture of cross-recessed screws of type H (Phillips) and Z (Posidriv) and of the special types of cross-recessed screws partly used having additionally widened diametrical slot, the original standard slotted screws have become undervalued on account of their disadvantages in respect of ensured centring for mainly mechanical screwdriving operations.

This conclusion is perfectly understandable, since, during screwdriving operations carried out nowadays, most of these cross-recessed applications simplify the working method on account of ensured centring for transmitting the common torques.

As alternatives, the “plus/minus cross-recessed screws” according to DIN 7962 having a full diametrical slot according to DIN 84 have likewise been produced, this in particular for increasing the torque transmission in screwed connections for maximum duty applications. The operation of centring cross-recessed screws during fully automatic screwdriving operations offers useful properties and simplifies their application.

For these and other reasons, the “cross-recessed screws” are being increasingly used.

However, when carrying out a basic and precise examination of the properties of cross-recessed screws, it is important to also be able to recognize their disadvantages, inter alia:
The common cross-recessed screws can be centred easily, but only by applying a centring pressure force which overcomes the ejection forces (come-out), and this by means of a requisite “contact pressure”, which at increased torques also has to be increased proportionally.
In heavy-duty torque applications and at an insufficient contact pressure, there is therefore the risk of the screwdriver/bit tip being thrown out of the cross recess.
This disadvantage exists in particular in the case of cross-recessed screws of type H (Phillips), in which all the walls and ribs of the cross recess are inclined in depth and therefore the components produce the ejection force on account of this geometry.
In the case of the more recent cross-recessed screws of type Z (Posidriv), the four tightening walls are perpendicular and only the tip is inclined; therefore the “ejection force” (come-out) is reduced to a minimum.
On account of the elevation geometry (surface of the cross recesses), their dimension is reduced relative to the diameter of the relevant screws, wherein the pressure forces of applied torques in the application of cross-recess geometries prove to be greater than in diagonally slotted screws, and these forces can only be distributed by the depression of the recess surfaces.
The result of this is that, in the case of cross-recessed screws having a lower degree of hardness or during torque overloading in the case of standard cross-recessed screws, the recess geometry is destroyed, and this during the screw-in operation and during their release.
During manual screwdriving of cross-recessed screws or using a corresponding mechanical screwdriving implement (screwdriving drill), a respective contact pressure is necessary, which, depending on the torque demand and on the operating position of the user required for this, can partly make the work to be carried out by the user extremely difficult.

It is therefore the object of the present invention to provide a diametrically slotted screw and a screwdriver tip/bit which avoid the aforesaid disadvantages of the cross-recessed screws. This object is basically achieved by the features of Claim 1 and by the subsequent specifications of the dependent claims.

### DESCRIPTION OF THE INVENTION

The invention is suitable for all renewable diametrically slotted screws according to DIN and ISO standards and for special embodiments according to non-metric threads and for screwdrivers which are intended for use with a handle and for the corresponding bit inserts for electrically or pneumatically driven screwdriving apparatuses. This invention permits the development of the existing standards of diametrically slotted screws with horizontal slot base plane having an additional centring device and, as a further possibility, the subsequent enlargement of the force transmission surfaces with slot base planes inclined outwards.

Two entirely related versions are therefore hereby described:
embodiment “A”, diametrically slotted screw with additional centring device and maximum enlargement of the force transmission surfaces with slot base planes inclined outwards;
embodiment “B”, diametrically slotted screw with additional centring device and normal enlargement of the force transmission surfaces with horizontal slot base plane.

On account of the geometry of the diametrically slotted screws, the principle of this invention is based on an increase in the torque transmission forces and on ensured centring of the screwdriver/bit tips, a property which does not exist in the common diametrically slotted screws currently available.

The following principles, which provide maximum force transmission of the torques and ensure centring in this invention, are therefore applied, in particular:
The presence of purely vertical or parallel contact surfaces for torque transmission in the diameter of the corresponding diametrical slot no longer produces any ejection forces (come-out); thus the full component of the torque can be transmitted starting from the centre of the axis of rotation.
The requisite force for centring the screwdriver/bit tip in the correspondingly adapted torque transmission surfaces is minimal and is not proportional to and not dependent on the torque transmission; unlike in the case of the cross-recessed screws, only this small contact pressure is necessary for ensuring the central position of the screwdriver/bit tip in the corresponding centring shape of the diagonal slot.
The centring of the screwdriver/bit tips is simplified with or without the hemispherical centring surface (15) on the screw head, wherein the half-round centring part of the screwdriver/bit tips is initially secured over the total turning angle of 180° and by the slight contact pressure before entering the diametrical slot.
The unit consisting of the vertical or parallel half-round centring surface together with the surface of the likewise vertical or parallel slot walls results in an overall enlargement of the torque transmission surfaces of over 150% compared with the currently available 100% of the conventional diametrically slotted screws. Therefore, when applying high torques, their force distribution to a single pressure surface not broken up by complementary pressure elements is of great advantage.
The increase in the force distribution surfaces at the outer ends of the diagonal slot contributes to this improved torque distribution. This applies in particular to the embodiment of type A.
The principle of the applied geometry of the half-round centring surface in the centre of the diagonal slot likewise makes possible, thanks to its proportions, its application in diametrically slotted countersunk screws, the cone surface of which has an external angle of 45°: this screw form, as viewed in overall vertical section, is the basic representation for the limit of centring slot embodiments in said screw head. The screwdriver/bit tip is correspondingly adapted in the case of these countersunk screws.
Therefore the present invention has been defined by this consideration and assumption for the entire application of the slotted screw types, wherein the screw head forms prove to have no effect on the configuration of the half-round centring surface and of the diagonal slot end surfaces, which can hereby be used in all types without manual and mechanical impairment.
By this description of the embodiment A for diametrically slotted screws, their adaptation can be achieved in a simple manner without technical complications, for the half-round centring surfaces and the sloping diametrical slot end surfaces can be incorporated during the production of the screws by means of hot forming.
On the basis of said concept, these novel diametrically slotted screws can likewise be used as in insertion solution with the currently conventional screwdrivers/bits, although without centring function and without an increase in the possible torques.

### Advantages of the Relevant Diametrically Slotted Screw Types A and B

These novel slotted screw types and their embodiment variants and the correspondingly produced screwdriver/bit tips can satisfy an increase in torque of over 50% compared with the analogous current slotted screw standard.
Due to the hemispherical centring surface (15) on the screw head and the half-round centring surface in the screw and the inclined outer surfaces of the diametrical slot and also the corresponding points of the screwdriver/bit tips, the centring is ensured before the screwdriving operation and thanks to the low contact pressure.
Contrary to the ejection forces in the case of cross-recessed screws, the “come-out forces” are no longer present in this invention, and the existing contact surfaces, in particular at the two ends of the turning slot, permit an optimum distribution of the torques.
Contrary to the ejection forces in the case of cross-recessed screws, the centring contact pressure in this invention is minimal and does not depend on and is not proportional to increasing torques.
The invention can be used for the renewal of all similar diametrically slotted screws available, including their countersunk head variants and the products according to DIN, ISO standards and analogous standards, together with special embodiments provided according to non-metric standards, and for medicinal applications.
The invention can thus be used for all diametrically slotted screws having a raised head, round head, countersunk head, cheese head, having an external square and external hexagon head, and for screw types used as wood screws, chipboard screws, dry-wall screws, self-drilling screws with wings, sheet-metal screws, drilling screws, thread-cutting screws, machine screws, plastic screws and corresponding special embodiments.
Thanks to this invention of diametrically slotted screws, the extensive application of standardized centring sleeves is no longer necessary; this results in cost, time and assembly advantages for these screw types.
On account of the existing hemispherical centring surface (15) on the screw heads of these diametrically slotted screws, the tool positioning with manual screwdrivers and industrial robots can be realized with little effort when screwing in and during dismantling processes.
In order to ensure the centring operation to an increased extent, the respective halves of the slot wall surfaces (9), with parallel reference to the longitudinal axis of the diametrical slot, are constructed at an angle of 0° to 20°, preferably 3°, and this in order to facilitate the insertion of the centring surfaces (5) and of the vertical screwdriving surfaces (1) of the screwdriver/bit tip to be received into the diametrical slot. This adaptation therefore guarantees the full parallel contact of the screwdriving surfaces (1) of the bits with the slot surfaces (9) of the diametrically slotted screw, a factor which makes possible maximum transmission of the turning forces to the entire contact surfaces present.
The technical outlay required for producing this diametrically slotted screw invention is commensurate with the applications and advantages, in particular the greater transmission of turning force, achieved by this simple solution.
The aim of the invention is to reassess and use again the diametrically slotted screw types and their screwdriver/bit tips thanks to the ensured centring and increase in the torques.

Due to the production of this screw invention and of the screwdriver and bit tips intended for it, it can be assumed that the renewed slotted screw types can gain in importance and be increasingly used again compared with the cross-recessed screws: this is the desired consequence for these inventive products, studies being started and contacts established for possible acceptance of this invention as a new standard for diametrically slotted screws.

In addition to the abovementioned diametrically slotted screws, this invention can also be applied to novel triple radially slotted screws (3R radially slotted screws). In the case of the latter, three vertically centred radial slots are arranged on the screw head instead of a single diametrical slot which can be centred, wherein each individual radial slot represent the exact half of the diametrical slot, and the three radial slots are connected to one another starting from their deepest point and along the vertical centre of the half-round centring surfaces.

Therefore said three individual radial slots are positioned on the screw head from the centre of the screw axis at an angle of 120° each and therefore constitute the unit of the triple radial slot.

On account of the geometry of the 3R radially slotted screws, the principle of this invention is based on an increase in the torque transmission forces and on ensured centring of the screwdriver/bit tips, a property which does not exist in the common slotted screws (still) available.

Due to the seating of the 3R bit on the corresponding base planes of the radial slots, the centring and the stability of the force transmission are ensured, the existing hemispherical centring surface likewise being present as in the diametrically slotted screws, which simplifies manual and mechanical centring of the bit in said radial slots.

### Advantages of the Relevant 3R Radially Slotted Screws of the A Types Provided

This 3R radially slotted screw type is based on the adaptation of the screw head to the 3R bit, which consists of three half and joined-together diametrical slot bits of type A (see sheet 1-A, FIG. 4), which ensure the pressure and centring stability by means of the base surfaces (3) inclined outwards and by means of the terminating end surfaces (16).
These novel 3R radially slotted screw types and their embodiment variants and also the correspondingly produced screwdriver/bit tips can accomplish an increase in torque of about +75% compared with the existing cross-recessed screws, and this with respect to the force applications which have to be used in the outermost force transmission zones in the screw heads.
Due to the hemispherical centring surface (15) on the screw head and the half-round centring surfaces (12), split in half, in the screw, the inclined base surfaces (10, 17) of the radial slots and the corresponding points of the screwdriver/bit tips (5, 6, 1), the centring is ensured with low contact pressure at the beginning, before the screwdriving operation and before the full force transmission.
Contrary to the ejection forces in the case of cross-recessed screws, the “come-out forces” are no longer present in this invention, and the existing contact surfaces, in particular at the three ends of the 3R radial slots, permit an optimum distribution of the torques to the maximum diameter of the screw head.
Contrary to the ejection forces in the case of cross-recessed screws, the centring contact pressure in this invention is minimal and is not proportional to increasing torques.
This invention can be used for the replacement of cross-recessed screws and for the renewal of existing countersunk screws, cheese head screws, round head screws and also raised countersunk head screws and analogous adapted products according to DIN and ISO standards and also according to other non-metric standards.
These novel 3R radially slotted screw types are therefore provided with standard 3R bits for the same screw sizes, which permits their simplified and polyvalent application in the case of said and renewed screw types.
Due to the production of this screw invention and of the screwdriver and bit tips intended for it, it can be assumed that the renewed 3R radially slotted screw types can gain in importance and be increasingly used compared with the cross-recessed screws and analogous products, and this with respect to ensured centring and the use of the maximum screw head diameters for the purpose of reducing the turning forces applied.
Thanks to this invention of 3R radially slotted screws, the extensive application of standardized centring sleeves is no longer necessary; this results in cost, time and assembly advantages for these screw types.
On account of the existing hemispherical centring surface (15) on the screw heads of these 3R radially slotted screws, the tool positioning with manual screwdrivers and industrial robots can be realized with little effort when screwing in and during dismantling processes.
Due to the use of the full radii of the screw heads and their division into 3×120° sections, the force distribution (in particular in the case of countersunk screws) is adapted to the maximum capacities acceptable, and this with the aim of protecting the force transmission surfaces from destruction, even during brief overloading.
In order to ensure the centring operation to an increased extent, the three halves of the slot wall surfaces (9), with parallel reference to the longitudinal axis of the 3R slot, are constructed at an angle of 0° to 20°, preferably 3°, and this in order to facilitate the insertion of the centring surfaces (5) and of the vertical screwdriving surfaces (1) of the screwdriver/bit tip to be received into the 3R slot. This adaptation therefore guarantees the full parallel contact of the screwdriving surfaces (1) of the bits with the slot surfaces (9) of the 3R radially slotted screw, a factor which makes possible maximum transmission of the turning forces to the entire contact surfaces present. (See illustration of sheet 9-A: detail/principle of the centring of 3R radially slotted screws.)

Further advantageous embodiments and combinations of features of the invention follow from the detailed description below and from the patent claims in their entirety.

### BRIEF DESCRIPTION OF THE DRAWINGS

The drawings used for the explanation of the exemplary embodiment show:

Sheet 1-A

Illustration of the inventive embodiment type A with the following drawings:

FIG. 1 Section A-A of the diametrically slotted screw without conical screw head underpart with the base surfaces (10), inclined outwards, of the diametrical slot and also the half-round centring surface (5) and the hemispherical centring surface (15).

FIG. 2 Horizontal top view of said screw surface (8) with (or without) the hemispherical centring surface (15) and the inclined (10) and the half-round centring surface (12).

FIG. 3 Section B-B with a view into the depth of the diametrical slot surfaces (9, 10) and (12) and also the seating of the screwdriver/bit tip on the hemispherical centring surface at an angle of 90° to the longitudinal axis of the diametrical slot surface.

FIG. 4 Section A-A as FIG. 1, but for the diametrically slotted countersunk screw with conical screw head underpart and adaptation of the screwdriver/bit tip (1) to countersunk shape by means of the corner surfaces (16) inclined by 45°.

FIG. 5 Horizontal top view of said screw surface (8) with (or without) the hemispherical centring surface (15) and the inclined (10) and the half-round centring surface (12).

FIG. 6 Section B-B with a view into the depth of the diametrical slot surfaces (9, 10) and (12) for the diametrically slotted countersunk screw with conical screw head underpart and also the seating of the screwdriver/bit tip on the hemispherical centring surface at an angle of 90° to the longitudinal axis of the diametrical slot surface.

Sheet 2-B

Illustration of the inventive embodiment type B with the follow drawings:

FIG. 7 Section A-A of the diametrically slotted screw without conical screw head underpart with the horizontal base surfaces (10) of the diametrical slot and also the half-round centring surface (5) and (or without) the hemispherical centring surface (15).

FIG. 8 Horizontal top view of said screw surface (8) with (or without) the hemispherical centring surface (15) and the horizontal (10) and the half-round centring surface (12).

FIG. 9 Section B-B with a view into the depth of the diametrical slot surfaces (9, 10) and (12) and also the seating of the screwdriver/bit tip on the hemispherical centring surface at an angle of 90° to the longitudinal axis of the diametrical slot surface.

FIG. 10 Detail of the screwdriver/bit tip (1) with the adapter corners (16), inclined by 45°, as a variant for use in the case of screws with and without conical screw head underpart.

FIG. 11 Section A-A as FIG. 1, but for the diametrically slotted countersunk screw with conical screw head underpart and adaptation of the screwdriver/bit tip (1) to countersunk shape by means of the adapted corner surfaces (16) inclined by 45°.

FIG. 12 Horizontal top view of said screw surface (8) with (or without) the hemispherical centring surface (15) and the horizontal (10) and the half-round centring surface (12).

FIG. 13 Section B-B with a view into the depth of the diametrical slot surfaces (10) and (12) for the diametrically slotted countersunk screw with conical screw head underpart and also the seating of the screwdriver/bit tip on (or without) the hemispherical centring surface at an angle of 90° to the longitudinal axis of the diametrical slot surface.

Sheet 3-A/B

Illustration of the inventive embodiments A and B with regard to the angle of the vertical or parallel diametrical screw slot surfaces (9) with widening of 3° within the range of 0° to 20°.

FIGS. 14/16 Section A-A similar to the preceding illustrations.

FIGS. 15/17 Horizontal top view of said screw surfaces (8) with (or without) the hemispherical centring surfaces (15) and the inner slot surfaces (9, 10) and the half-round centring surfaces (12). By widening of the angle of the inner surfaces (9) in parallel with respect to the longitudinal axis of the diametrical slot, the entry of the screwdriver/bit tip is positioned after a maximum turning angle of 180° (=+/−90°). (See detail sheet 10-A/B.)

Sheet 4-A:

Illustration of the inventive embodiments of the versions A with adaptation of the screw slots of the cheese head screw to the bit designed for the countersunk screw and having the corner surfaces (16) which are inclined by 45° and correspond to the outer surfaces (19) in the case of said cheese head screw.

FIG. 18 Section A-A of the diametrically slotted cheese head screw with the base surfaces (10), inclined outwards, of the diametrical slot and the corner surfaces (19) inclined by 45° and also the half-round centring surface of the bit (5) and the hemispherical centring surface (15) of the screw head.

FIG. 19 Horizontal top view of said screw surface (8) with the hemispherical centring surface (15) and the slot base surface (10) inclined outwards, the corner surfaces (19) inclined by 45° and also the half-round centring surface (12).

FIG. 20 Section B-B with a view into the depth of the diametrical slot surfaces (9, 10) and (12) and also the seating of the screwdriver/bit tip on the hemispherical centring surface (15) at an angle of 90° to the longitudinal axis of the diametrical slot surface.

FIGS. 21-23 correspond to the equivalent illustrations and details as application references with respect to FIGS. 4, 5 and 6 of sheet 1-A. They therefore serve as a basis for the A bit for the countersunk screw (sheet 1-A) and its use as polyvalent bit tip for adapted cheese head screws and round head screws, which enables this bit to be used for said screw types (incl. raised countersunk head screws) at the same sizes.

Sheet 5-A:

Illustration of the inventive embodiments of the versions A with adaptation of the screw slots of the round head screw to the bit designed for the countersunk screw and having the corner surfaces (16) which are inclined by 45° and correspond to the outer surfaces (19) in the case of said round head screw.

FIG. 24 Section A-A of the diametrically slotted round head screw with the base surfaces (10), inclined outwards, of the diametrical slot and the corner surfaces (19) inclined by 45° and also the half-round centring surface of the bit (5) and the hemispherical centring surface (15) of the screw head.

FIG. 25 Horizontal top view of said screw surface (8) with the hemispherical centring surface (15) and the slot base surface (10) inclined outwards, the corner surfaces (19) inclined by 45° and also the half-round centring surface (12).

FIG. 26 Section B-B with a view into the depth of the diametrical slot surfaces (9, 10) and (12) and also the seating of the screwdriver/bit tip on the hemispherical centring surface (15) at an angle of 90° to the longitudinal axis of the diametrical slot surface.

Sheet 6-A: Centring of 3R Radially Slotted Countersunk Screws:

1. Seating of the 3R Bit Tip on the Hemispherical Centring Surfaces (15).

FIG. 27 Front view of the 3R bit tip for seating on the three hemispherical centring surface parts (15) on the screw head.

FIG. 28 Illustration of the horizontal section A-A of the 3R bit for its positioning on the screw head.

FIG. 29 Top view of the screw head of the 3R countersunk screw with the three units of the screw head surface (8) and the positioning of the 3R bit (FIG. 28). See detailed illustration sheet 9-A!

FIG. 30 Front illustration of the 3R bit tip (FIG. 27) before it has been seated on the 3R countersunk screw.

FIG. 31 Front view of the 3R countersunk screw with the supported 3R bit.

2. Turning the 3R Bit Tip by 60° on the Hemispherical Centring Surfaces (15) and Lowering into the 3R Radially Slotted Screw Surfaces (9).

FIG. 32 Illustration of the same 3R bit tip (FIG. 27) after its has been turned clockwise by 60°.

FIG. 33 Horizontal section A-A of the 3R bit after it has been turned by 60°.

FIG. 34 Top view of the screw head of the 3R countersunk screw with the three units of the screw head surfaces (8) which ensure the lowering of the 3R bit into the 3R radial screw slot surfaces (9) after it has been turned by 60°. See detailed illustration sheet 9-A!

FIG. 35 Illustration of the same 3R bit tip (FIG. 27) after its has been turned clockwise by 60°.

FIG. 36 Front illustration of the positioned and lowered 3R bit in the 3R radial screw slot surfaces (9).

Sheet 7-A: Centring of 3R Radially Slotted Cheese Head Screws:

1. Seating of the 3R Bit Tip on the Hemispherical Centring Surfaces (15).

FIG. 37 View of the 3R bit tip similar to FIG. 27 of sheet 6-A.

FIG. 38 Illustration of the horizontal section A-A of the 3R bit similar to FIG. 28 of sheet 6-A.

FIG. 39 Top view of the screw head of the 3R radially slotted cheese head screw with the three units of the screw head surface (8) and the positioning of the 3R bit (FIG. 38). See sheet 9-A!

FIG. 40 View of the 3R bit tip similar to FIG. 27 of sheet 6-A.

FIG. 41 Front view of the 3R radially slotted cheese head screw with the supported 3R bit.

2. Turning the 3R Bit Tip by 60° on the Hemispherical Centring Surfaces (15) and Lowering into the 3R Radially Slotted Screw Surfaces (9).

FIG. 42 Illustration of the same 3R bit tip (FIG. 27) after its has been turned clockwise by 60°.

FIG. 43 Horizontal section A-A of the 3R bit after it has been turned by 60°.

FIG. 44 Top view of the screw head of the 3R radially slotted cheese head screw with the three units of the screw head surfaces (8) which ensure the lowering of the 3R bit into the 3R radial screw slot surfaces (9) after it has been turned by 60°. See sheet 9-A!

FIG. 45 Illustration of the same 3R bit tip (FIG. 42) after its has been turned clockwise by 60°.

FIG. 46 Front illustration of the positioned and lowered 3R bit in the 3R radial screw slot surfaces (9).

Sheet 8-A: Centring of 3R Radially Slotted Round Head Screws:

1. Seating of the 3R Bit Tip on the Hemispherical Centring Surfaces (15).

FIG. 47 View of the 3R bit tip similar to FIG. 27 of sheet 6-A.

FIG. 48 Illustration of the horizontal section A-A of the 3R bit similar to FIG. 28 of sheet 6-A.

FIG. 49 Top view of the screw head of the 3R radially slotted round head screw with the three units of the screw head surface (8) and the positioning of the 3R bit (FIG. 48). See detail sheet 9-A!

FIG. 50 Front illustration of the 3R bit tip (FIG. 47) before it has been seated on the 3R radially slotted round head screw.

FIG. 51 Front view of the 3R radially slotted round head screw with the supported 3R bit.

2. Turning the 3R Bit Tip by 60° on the Hemispherical Centring Surfaces (15) and Lowering into the 3R Radially Slotted Screw Surfaces (9).

FIG. 52 Illustration of the same 3R bit tip (FIG. 47) after it has been turned clockwise by 60°.

FIG. 53 Horizontal section A-A of the 3R bit after it has been turned by 60°.

FIG. 54 Top view of the screw head of the 3R radially slotted round head screw with the three units of the screw head surfaces (8) which ensure the lowering of the 3R bit into the 3R radial screw slot surfaces (9) after it has been turned by 60°. See detail sheet 9-A!

FIG. 55 Front view of the 3R bit tip (FIG. 52) before it has been lowered into the 3R radially slotted round head screw.

FIG. 56 Front illustration of the positioned and lowered 3R bit in the 3R radial screw slot surfaces (9).

Sheet 9-A: Detail/Principle of the Centring of 3R Radially Slotted Screws:

FIG. 57 Illustration of the insertion of the 3R bit into the 3R radial slot surfaces of the screw head with the clearances which are produced by the two a° angles.

FIG. 58 Illustration of the seating of the bit slot surfaces (1) in direct contact with the 3R radially slotted screw surfaces (9) after the 3R bit has been turned by the a° angle.

Sheet 10-A: Detail/Principle of the Centring of Diametrically Slotted Screws

FIG. 59 Illustration of the insertion of the diametrically slotted screw bit into the diametrical slot surfaces of the screw head with the clearances which are produced by the two a° angles.

FIG. 60 Illustration of the seating of the bit slot surfaces in direct contact with the diametrically slotted screw surfaces after the bit has been turned by the a° angle.

### WAYS OF IMPLEMENTING THE INVENTION

### Sheet 1-A

These basic drawings comprise the diametrically slotted screw types of the description of the invention for screws of embodiment A with and without conical screw head underpart.

FIG. 1 is the illustration of the corresponding screwdriver/bit tip, the vertical or parallel transmission surface (1) being defined by the sloping seating surface (3), the half-round centring point (5) and the extension angle rounded portion (4) and also the deepest inner centring point (6). The deepest outer corners of the screwdriver/bit tip are represented by (2), which corresponds with the outer end (14) of the diametrical slot. The centring and the full drive connection of the screwdriver/bit tip is established by means of the illustration of the insertion direction into the diametrical slot of the screw (by the arrows present).

The section A-A of the screw is shown according to FIG. 1, wherein the screw head top surface (8), with (or without) the hemispherical centring surface (15), and the inner slot wall surfaces (9), the inclined base plane of the diametrical slot (10) and also the semicircular centring surface (12) and its deepest centring point (13) are designated. At the semicircular centring surface (12), in order to reduce the point-like stresses, the extension of said semicircular centring surface (12) to the inclined base plane (10) of the diametrical slot is provided by two rounded portions (11) at the highest point of the extension angle, and the deepest point of the sloping arrangement is shown by (14).

FIG. 2 shows the top view of the diametrically slotted screw without conical screw head underpart, wherein the screw surface (8), the vertical or parallel slot walls (9) and also the inner surface parts (11, 12, 13) of the diametrical slot and the parts of the (or without the) embodied hemispherical centring surface (15) are designated.

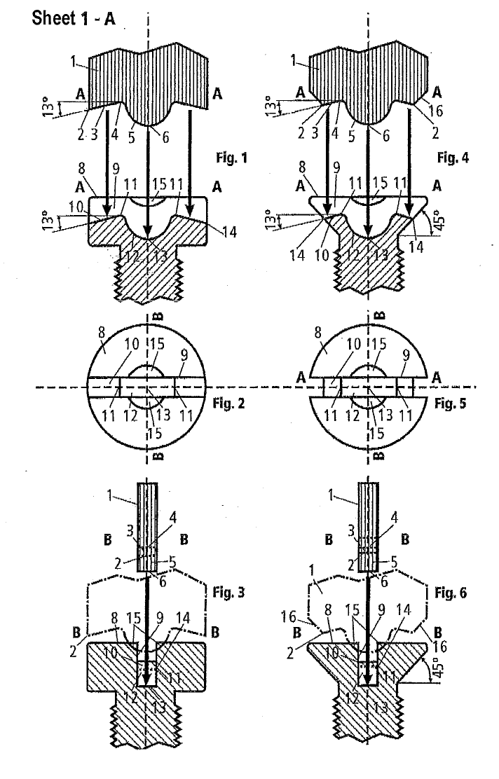

FIG. 3 concerns the section B-B with the illustration of the screwdriver/bit tip with said screwdriver/bit tip seated on (or without) the hemispherical centring surface parts (15) at an angle of 90° to the longitudinal axis of the diametrical slot surface. By these hemispherical centring surfaces (15) present (or not present), the entry of the screwdriver/bit tip into the diametrical slot is pre-positioned after a maximum turning angle of 180° (=+/−)90°.

FIG. 4 in section A-A is similar to FIG. 1, but with the difference that the diametrically slotted screw type is illustrated with a conical screw head underpart.

All the part designations correspond to the details of FIG. 1, with the exception of the adapted corner surfaces (16) of the screwdriver/bit tip (1) for adaptation to the outer (14) inclined base surfaces (10).

FIG. 5 shows, like FIG. 2, the analogous top view of the diametrically slotted screw having a conical screw head underpart, wherein the screw surface (8), the vertical or parallel slot walls (9) and also the inner surface parts (11, 12, 13) of the diametrical slot and the parts of the hemispherical centring surfaces (15) embodied (or not embodied) are designated.

FIG. 6 shows, like FIG. 3, the section B-B with the illustration of the screwdriver/bit tip, said screwdriver/bit tip, when seated (or when not seated) on the hemispherical centring surface parts (15), being positioned (or not being positioned) at an angle of 90° to the longitudinal axis of the diametrical slot surface.

With these hemispherical centring surfaces (15), the entry of the screwdriver/bit tip into the diametrical slot is pre-centred after a maximum turning angle of 180° (=+/−)90°.

### Sheet 2-B

These basic drawings comprise the diametrically slotted screw types of the description of the invention for screws of embodiment B with and without conical screw head underpart.

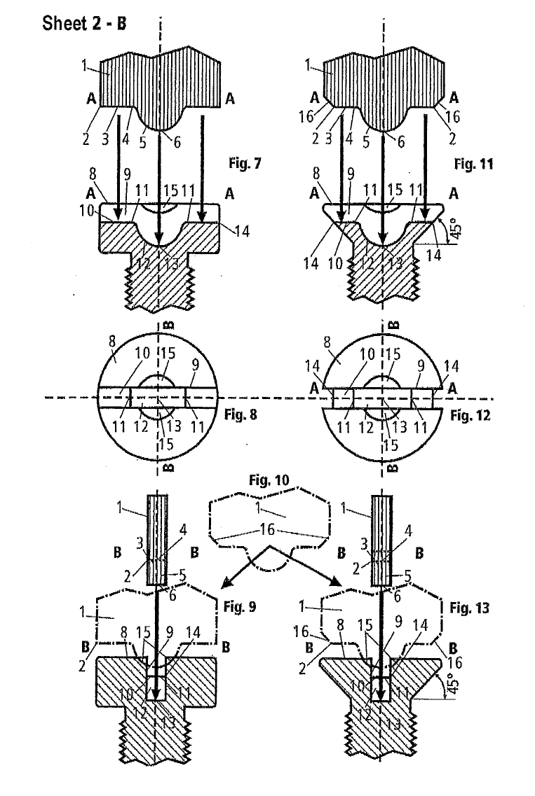

FIG. 7 is the illustration of the corresponding screwdriver/bit tip, the vertical or parallel transmission surface (1) being defined by the horizontal seating surface (3), the half-round centring point (5) and the extension angle rounded portion (4) and also the deepest inner centring point (6). The deepest outer corners of the screwdriver/bit tip is represented by (2), which corresponds with the outer end (14) of the diametrical slot.

The centring and the full drive connection of the screwdriver/bit tip is established by means of the illustration of the insertion direction into the diametrical slot of the screw (by the arrows present).

The section A-A of the screw is shown according to FIG. 7, wherein the screw head top surface (8), with (or without) the hemispherical centring surface (15), and the inner slot wall surfaces (9), the inclined base plane (10) of the diametrical slot and also the semicircular centring surface (12) and its deepest centring point (13) are designated. At the semicircular centring surface (12), in order to reduce the point-like stresses, the extension of said semicircular centring surface (12) to the inclined base plane (10) of the diametrical slot is provided by two rounded portions (11) at the highest point of the extension angle, and the deepest point of the sloping arrangement is shown by (14).

FIG. 8 shows the top view of the diametrically slotted screw without conical screw head underpart, wherein the screw surface (8), the vertical or parallel slot walls (9) and also the inner surface parts (11, 12, 13) of the diametrical slot and the hemispherical (or not hemispherical) centring surfaces (15) are designated.

FIG. 9 concerns the section B-B with the illustration of the screwdriver/bit tip with said screwdriver/bit tip seated on the hemispherical centring surface parts (15) at an angle of 90° to the longitudinal axis of the diametrical slot surface. By these hemispherical centring surfaces (15), the entry of the screwdriver/bit tip into the diametrical slot is pre-positioned after a maximum turning angle of 180° (=+/−)90°.

FIG. 11 in section A-A is similar to FIG. 7, but with the difference that the diametrically slotted screw type is illustrated with a conical screw head underpart. All the part designations correspond to the details of FIG. 7, with the exception of the adapted corner surfaces (16) of the screwdriver/bit tip (1) for adaptation to the outer (14) inclined base surfaces (10).

FIG. 12 shows, like FIG. 8 the analogous top view of the diametrically slotted screw having a conical screw head underpart, wherein the screw surface (8), the vertical or parallel slot walls (9) and also the inner surface parts (11, 12, 13) of the diametrical slot and (or without) the hemispherical centring surfaces (15) embodied are designated.

FIG. 13 shows, like FIG. 9, the section B-B with the illustration of the screwdriver/bit tip, with said screwdriver/bit tip seated on (or without) the hemispherical centring surface parts (15) at an angle of 90° to the longitudinal axis of the diametrical slot surface. By these (or without these) hemispherical centring surfaces (15), the entry of the screwdriver/bit tip into the diametrical slot is pre-positioned after a maximum turning angle of 180° (=+/−)90°.

FIG. 10 indicates the screwdriver/bit tip (1) with the adapted corners (16), inclined at 45°, as a variant for use in the case of screws with or without conical head underpart.

### Sheet 3-A/B

Illustration of the inventive embodiments A and B with regard to the angle of the vertical diametrical screw slot surfaces (9) with widening of 3° within the range of 0° to 20°.

FIGS. 14/16—section A-A similar to the preceding illustrations.

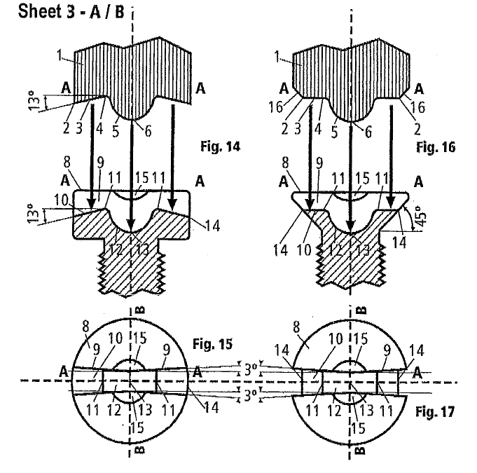

FIGS. 15/17—horizontal top view of said screw surfaces (8) with the hemispherical centring surfaces (15) and the inner slot surfaces (10) and the half-round centring surfaces (12). By widening of the angle of the inner surfaces (9) in parallel with respect to the longitudinal axis of the diametrical slot, the entry of the screwdriver/bit tip is positioned after a maximum turning angle of 180° (=+/−)90°. (See detail of centring and force transmission sheet 10-A/B.)

### Sheet 4-A

These basic drawings comprise the diametrically slotted screw types of the description of the invention for screws of embodiment A with and without conical screw head underpart.

FIG. 18 is the illustration of the corresponding screwdriver/bit tip, the vertical or parallel transmission surface (1) being defined by the sloping seating surface (3), the half-round centring point (5) and the extension angle rounded portion (4) and also the deepest inner centring point (6). The deepest outer corners of the screwdriver/bit tip are represented by (2), which corresponds with the outer end (14) of the diametrical slot. The centring and the full drive connection of the screwdriver/bit tip is established by means of the illustration of the insertion direction into the diametrical slot of the screw (by the arrows present).

The section A-A of the screw is shown according to FIG. 18, wherein the screw head top surface (8), with the hemispherical centring surface (15), and the inner slot wall surfaces (9), the inclined base plane of the diametrical slot (10), the outer corner surface (19), inclined by 45°, with its deepest (17) and highest edges (18), and also the semicircular centring surface (12) and its deepest centring point (13) are designated. At the semicircular centring surface (12), in order to reduce the point-like stresses, the extension of said semicircular centring surface (12) to the inclined base plane (10) of the diametrical slot is provided by two rounded portions (11) at the highest point of the extension angle, and the deepest point of the sloping arrangement is shown by (17).

FIG. 19 shows the top view of the diametrically slotted screw without conical screw head underpart, wherein the screw surface (8), the vertical or parallel slot walls (9) and also the inner surface parts (11, 12, 13) of the diametrical slot and the parts of the embodied hemispherical centring surface (15) are designated.

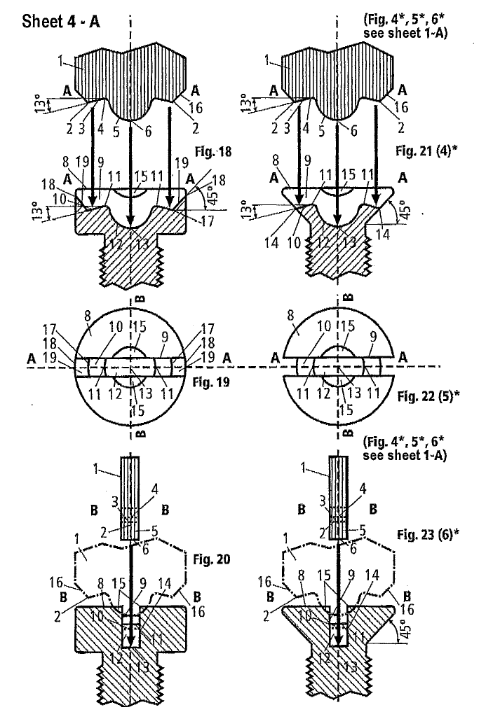

FIG. 20 concerns the section B-B with the illustration of the screwdriver/bit tip with said screwdriver/bit tip seated on (or without) the hemispherical centring surface parts (15) at an angle of 90° to the longitudinal axis of the diametrical slot surface. By these hemispherical centring surfaces (15) present, the entry of the screwdriver/bit tip into the diametrical slot is pre-positioned after a maximum turning angle of 180° (=+/−)90°.

FIGS. 21, 22, 23 correspond to the equivalent illustrations and details as application references with respect to FIGS. 4, 5 and 6 of sheet 1-A. They therefore serve as a basis for the A bit for the countersunk screw (sheet 1-A) and its use as polyvalent bit tip for adapted cheese head screws, round head screws and raised countersunk head screws, which enables this bit to be used for said screw types at the same sizes.

### Sheet 5-A

These basic drawings comprise the diametrically slotted screw types of the description of the invention for round head screws of embodiment A without conical screw head underpart.

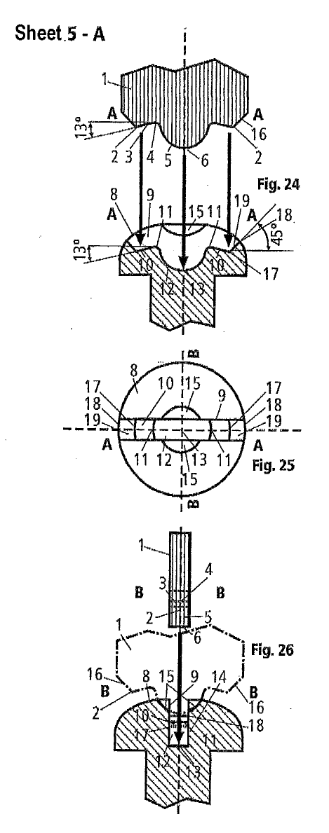

FIG. 24 is the illustration of the corresponding screwdriver/bit tip, the vertical or parallel transmission surface (1) being defined by the sloping seating surface (3), the half-round centring point (5) and the extension angle rounded portion (4) and also the deepest inner centring point (6). The deepest outer corners of the screwdriver/bit tip are represented by (2), which corresponds with the outer end (14) of the diametrical slot. The centring and the full drive connection of the screwdriver/bit tip is established by means of the illustration of the insertion direction into the diametrical slot of the screw (by the arrows present).

The section A-A of the screw is shown according to FIG. 24, wherein the half-round screw head top surface (8), with the hemispherical centring surface (15), and the inner slot wall surfaces (9), the inclined base plane of the diametrical slot (10), the outer corner surface (19), inclined by 45°, with its deepest (17) and highest edges (18), and also the semicircular centring surface (12) and its deepest centring point (13) are designated. At the semicircular centring surface (12), in order to reduce the point-like stresses, the extension of said semicircular centring surface (12) to the inclined base plane (10) of the diametrical slot is provided by two rounded portions (11) at the highest point of the extension angle, and the deepest point of the sloping arrangement is shown by (17).

FIG. 25 shows the top view of the diametrically slotted screw without conical screw head underpart, wherein the half-round screw surface (8), the vertical or parallel slot walls (9) and also the inner surface parts (11, 12, 13) of the diametrical slot and the parts of the embodied hemispherical centring surface (15) are designated.

FIG. 26 concerns the section B-B with the illustration of the screwdriver/bit tip with said screwdriver/bit tip seated on the hemispherical centring surface parts (15) at an angle of 90° to the longitudinal axis of the diametrical slot surface. By these hemispherical centring surfaces (15) present, the entry of the screwdriver/bit tip into the diametrical slot is pre-positioned after a maximum turning angle of 180° (=+/−)90°.

### Sheet 6-A

### Centring of 3R Radially Slotted Countersunk Screws

1. Seating of the 3R Bit Tip on the Hemispherical Centring Surfaces (15).

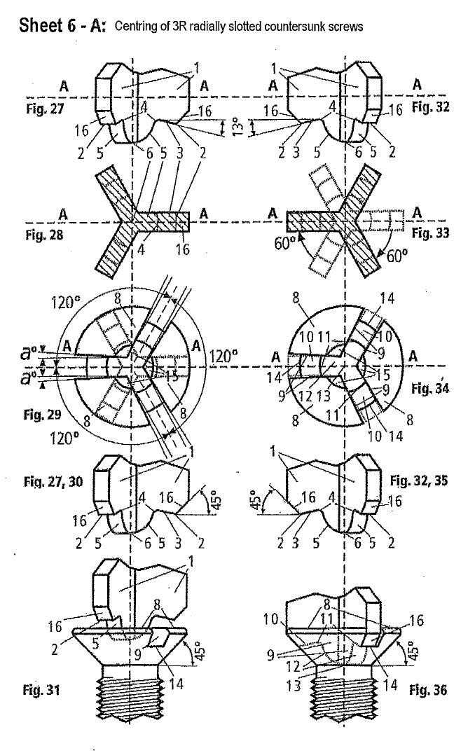

FIG. 27 is the illustration of the vertically centred screwdriver/bit tip which is joined together from three half diametrical slots and whose individual vertical or parallel force transmission surfaces (1), starting from the deepest point (6) of the half-round centring surface (5), are likewise connected vertically at a horizontal orientation angle of 120° to form a unit. Therefore these individual and identical bit lobes have a deepest outer edge (2) of the screwdriver/bit tip, an outer corner surface of 45° (16) and a seating surface (3) which is inclined outwards and which is connected by an extension angle rounded portion (4) to the half-rounded centring surface (5).

FIG. 28 shows the horizontal section A-A of the screwdriver/bit tip, the use of which when seated on the screw head of the 3R radially slotted countersunk screw establishes the angle for centring.

FIG. 29 shows the vertical top view of the screw head, wherein, with the above horizontal section of the 3R bit (FIG. 28) shown in broken lines, its symmetrical centring on the individual screw head surfaces (8) is made possible and ensured, and thanks to the three individual parts (15) of the hemispherical centring surfaces. See detail sheet 9-A!

FIG. 30 is the identical front illustration of the 3R bit (FIG. 27) before it is seated on the three individual hemispherical centring surfaces (15), which are incorporated in the vertical/axial centre at the three individual screw head surfaces (8).

FIG. 31 is the front illustration of the 3R bit, supported by the hemispherical centring surfaces (15), on the 3R radially slotted countersunk screw head. After said 3R bit is subsequently turned clockwise by 60°, the outer corner surfaces (16) are put into the still open visible outer slots (9) of the vertical or parallel contact surfaces.

2. Turning the 3R Bit Tip by 60° on the Three Hemispherical Centring Surfaces (15) and Lowering into the 3R Radially Slotted Screw Surfaces (9).

FIG. 32—illustration of the screwdriver/bit tip according to FIG. 27, but after it has been turned clockwise by 60°.

FIG. 33 shows the horizontal section A-A of the screwdriver/bit tip, the use of which when seated and turned clockwise by 60° on the screw head of the 3R radially slotted countersunk screw establishes the angle for lowering.

FIG. 34 shows the vertical top view of the screw head, which has the same established basic position as in FIG. 29 and, thanks to the three individual parts (15) of the hemispherical centring surfaces and the parallel or vertical slot surfaces (9), enables the 3R bit to be lowered. The direct centring contact of the 3R bit is therefore established by its seating on the surfaces (10) inclined outwards by 13°, the outer edges (14), the highest extension angle rounded portions (11), the half-round centring surfaces (12) and the axial screw centre (13). See detail sheet 9-A!

FIG. 35 is the identical front illustration of the 3R bit (FIG. 32) after it has been turned clockwise by 60° and before it has been seated on the three individual hemispherical centring surfaces (15).

FIG. 36 is the front illustration of the lowering of the 3R screwdriver/bit tip into the corresponding screw slots. The centring of the 3R bit is therefore ensured thanks to its direct seating on the inclined outer surfaces (10), the extension angle rounded portions (11), the screw head centre (13) and the half-round centring surfaces (12).

### Sheet 7-A

### Centring of 3R Radially Slotted Cheese Head Screws

1. Seating of the 3R Bit Tip on the Hemispherical Centring Surfaces (15).

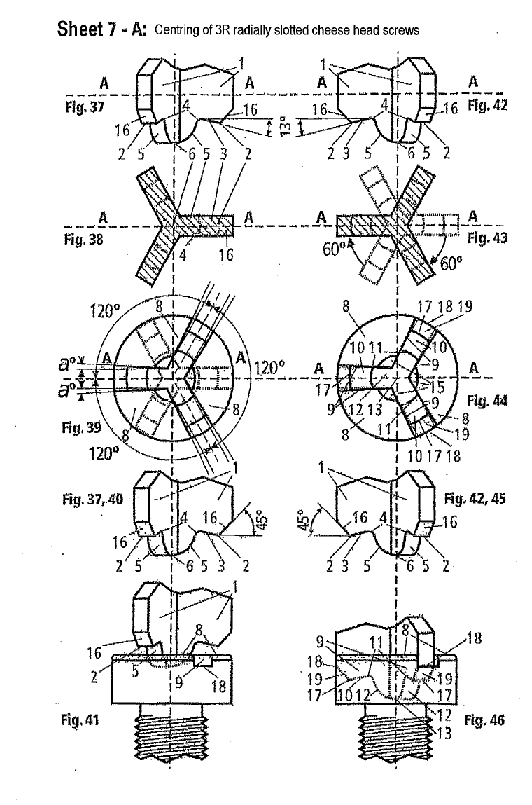

FIG. 37 is the illustration of the vertically centred screwdriver/bit tip which is joined together from three half diametrical slots and whose individual vertical or parallel force transmission surfaces (1), starting from the deepest point (6) of the half-round centring surface (5), are likewise connected vertically at a horizontal orientation angle of 120° to form a unit. Therefore these individual and identical bit lobes have a deepest outer edge (2) of the screwdriver/bit tip, an outer corner surface of 45° (16) and a seating surface (3) which is inclined outwards and which is connected by an extension angle rounded portion (4) to the half-rounded centring surface (5).

FIG. 38 shows the horizontal section A-A of the screwdriver/bit tip, the use of which when seated on the screw head of the 3R radially slotted cheese head screw establishes the angle for centring.

FIG. 39 shows the vertical top view of the screw head, wherein, with the above horizontal section of the 3R bit (FIG. 38) shown in broken lines, its symmetrical centring on the individual screw head surfaces (8) is made possible and ensured, and thanks to the three individual parts (15) of the hemispherical centring surfaces. See detail sheet 9-A!

FIG. 40 is the identical front illustration of the 3R bit (FIG. 37) before it is seated on the three individual hemispherical centring surfaces (15), which are incorporated in the vertical/axial centre at the three individual screw head surfaces (8).

FIG. 41 is the front illustration of the 3R bit, supported by the hemispherical centring surfaces (15), on the 3R radially slotted cheese screw head. After said 3R bit is subsequently turned clockwise by 60°, the outer corner surfaces (16), inclined by 45°, are put into the still open visible outer slots (9) of the vertical or parallel contact surfaces, wherein the outer edges (18) of the corresponding corner surfaces (19), inclined by 45°, of the screw head establish their reception of the 3R bit corner surfaces (16).

2. Turning the 3R Bit Tip by 60° on the Three Hemispherical Centring Surfaces (15) and Lowering into the 3R Radially Slotted Screw Surfaces (9).

FIG. 42—illustration of the screwdriver/bit tip according to FIG. 37, but after it has been turned clockwise by 60°.

FIG. 43 shows the horizontal section A-A of the screwdriver/bit tip, the use of which when seated and turned clockwise by 60° on the screw head of the 3R radially slotted cheese head screw establishes the angle for its lowering.

FIG. 44 shows the vertical top view of the screw head, which has the same established basic position as in FIG. 39 and, thanks to the three individual parts (15) of the hemispherical centring surfaces and the parallel or vertical slot surfaces (9), enables the 3R bit to be lowered. The direct centring contact of the 3R bit is therefore established by its seating on the surfaces (10) inclined outwards by 13°, the outer edges (18), the corner surfaces (19) inclined by 45°, the highest extension angle rounded portion (11), the half-round centring surfaces (12) and the axial screw centre (13). See detail sheet 9-A!

FIG. 45 is the identical front illustration of the 3R bit (FIG. 42) after it has been turned clockwise by 60° and before it has been seated on the three individual hemispherical centring surfaces (15).

FIG. 46 is the front illustration of the lowering of the 3R screwdriver/bit tip into the corresponding screw slots. The centring of the 3R bit is therefore ensured thanks to its direct seating on the corner surfaces (19) inclined by 45°, the adjoining surface edges (17), the surfaces (10) inclined outwards, the extension angle rounded portions (11), the screw head centre (13) and the half-round centring surfaces (12).

### Sheet 8-A Centring of 3R Radially Slotted Round Head Screws

1. Seating of the 3R Bit Tip on the Hemispherical Centring Surfaces (15).

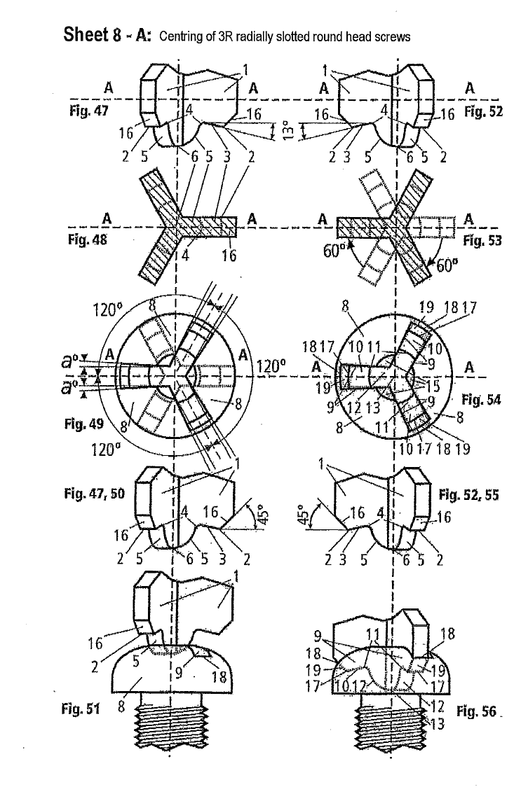

FIG. 47 is the illustration of the vertically centred screwdriver/bit tip which is joined together from three half diametrical slots and whose individual vertical or parallel force transmission surfaces (1), starting from the deepest point (6) of the half-round centring surface (5), are likewise connected vertically at a horizontal orientation angle of 120° to form a unit. Therefore these individual and identical bit lobes have a deepest outer edge (2) of the screwdriver/bit tip, an outer corner surface of 45° (16) and a seating surface (3) which is inclined outwards and which is connected by an extension angle rounded portion (4) to the half-rounded centring surface (5).

FIG. 48 shows the horizontal section A-A of the screwdriver/bit tip, the use of which when seated on the screw head of the 3R radially slotted round head screw establishes the angle for centring.

FIG. 49 shows the vertical top view of the screw head, wherein, with the above horizontal section of the 3R bit (FIG. 48) shown in broken lines, its symmetrical centring on the individual screw head surfaces (8) is made possible and secured, and thanks to the three individual parts (15) of the hemispherical centring surfaces. See detail sheet 9-A!

FIG. 50 is the identical front illustration of the 3R bit (FIG. 47) before it is seated on the three individual hemispherical centring surfaces (15), which are incorporated in the vertical/axial centre at the three individual screw head surfaces (8).

FIG. 51 is the front illustration of the 3R bit, supported by the hemispherical centring surfaces (15), on the round 3R radially slotted screw head. After said 3R bit is subsequently turned clockwise by 60°, the outer corner surfaces (16), inclined by 45°, are put into the still open visible outer slots (9) of the vertical or parallel contact surfaces, wherein the outer edges (18) of the corresponding corner surfaces (19), inclined by 45°, of the screw head establish their reception of the 3R bit corner surfaces (16).

2. Turning the 3R Bit Tip by 60° on the Three Hemispherical Centring Surfaces (15) and Lowering into the 3R Radially Slotted Screw Surfaces (9).

FIG. 52—illustration of the screwdriver/bit tip according to FIG. 47, but after it has been turned clockwise by 60°.

FIG. 53 shows the horizontal section A-A of the screwdriver/bit tip, the use of which when seated and turned clockwise by 60° on the screw head of the 3R radially slotted round head screw establishes the angle for its lowering.

FIG. 54 shows the vertical top view of the screw head, which has the same established basic position as in FIG. 49 and, thanks to the three individual parts (15) of the hemispherical centring surfaces and the parallel or vertical slot surfaces (9), enables the 3R bit to be lowered. The direct centring contact of the 3R bit is therefore established by its seating on the surfaces (10) inclined outwards by 13°, the outer edges (18), the corner surfaces (19) inclined by 45°, the highest extension angle rounded portion (11), the half-round centring surfaces (12) and the axial screw centre (13). See detail sheet 9-A!

FIG. 55 is the identical front illustration of the 3R bit (FIG. 52) after it has been turned clockwise by 60° and before it has been seated on the three individual hemispherical centring surfaces (15).

FIG. 56 is the front illustration of the lowering of the 3R screwdriver/bit tip into the corresponding screw slots. The centring of the 3R bit is therefore ensured thanks to its direct seating on the corner surfaces (19) inclined by 45°, the adjoining surface edges (17), the surfaces (10) inclined outwards, the extension angle rounded portions (11), the screw head centre (13) and the half-round centring surfaces (12).

### Sheet 9-A

### Detail/Principle of the Centring of 3R Radially Slotted Screws

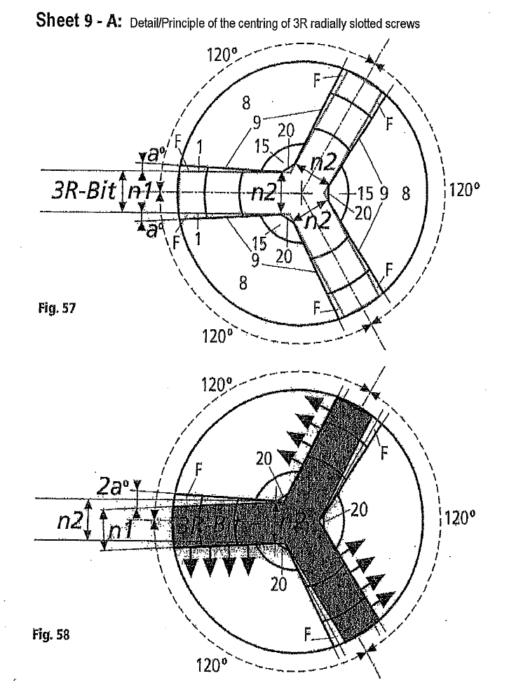

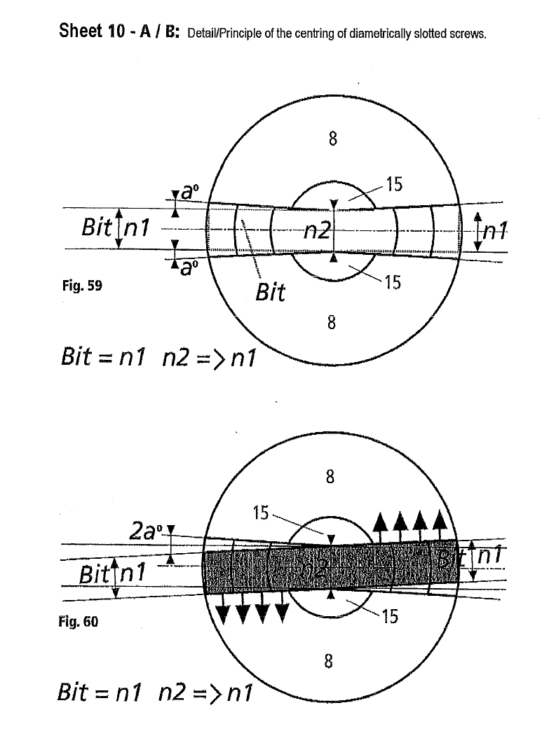

FIG. 57—illustration of the clearances (F) which are produced between the bit surfaces (1) and the 3R radially slotted screw surfaces (9) by the two a° angles. The lowering of the 3R bit into the slotted screw surfaces (9) is ensured thanks to the three hemispherical centring surface parts (15), wherein each of the two a° angles, within a range of 0 to 5°, preferably 3°, (within the range of 0° to 20° in the case of the diametrically slotted screws), produce the clearances for this centring operation. The width of the 3R radial bit part between the two contact surfaces (1) is therefore designated by n1, and the maximum slot width is designated by n2. The aim of this centring operation is for the width of the 3R radial bit part (n1) to correspond exactly or with a very small reduction in size to the maximum slot width of the screw head (n2) (20), whereby the parallel full force transmission is ensured.

FIG. 58—illustration of the seating of the bit slot surfaces (1) in direct contact with the 3R radially slotted screw surfaces (9) after the 3R bit has been turned by the a° angle. The turning forces are thus transmitted to the full slots surfaces (1), (9).

1. A Slotted screw which has slot surfaces on the screw head, wherein the slot surfaces are vertical or approximately vertical and are arranged parallel to one another or approximately parallel to one another, wherein the slotted screw, furthermore, has slot seating surfaces, inclined outwards at an angle within the range of 0° to 20°, and a half-round and deepened centring surface with its deepest point, said centring surface being located in the centre by rounded-off point surfaces, wherein the slotted screw is designed in such a way that a tip, to be received, for manual screwdrivers/bits and for screwdriving apparatuses, by means of its screwdriving surfaces, which are vertical or approximately vertical and which are arranged parallel to one another or approximately parallel to one another, and by means of the corresponding slot seating surfaces and a half-round and raised centring surface with its highest point which centring surface is located in the centre by rounded-off corner surfaces, can ensure the centring of the screwdriver/bit tips in the slotted screw for insertion and for the start of and during the screwdriving operation.

2. The slotted screw according to claim 1, characterized in that the slotted screw is designed as a diametrically slotted screw having a diametrical slot, wherein the slotted screw has two slot seating surfaces inclined outwards at an angle within a range of 0° to 20° and the centring surface is located in the centre by two rounded-off point surfaces.

3. The slotted screw according to claim 1, characterized in that the slotted screw is designed as a triple radially slotted screw and has on the screw head three vertically connected half and double-sided diametrical slot surfaces which are each offset from one another by an angle of 120° relative to a vertical centring axis, wherein the slotted screw has three slot seating surfaces inclined outwards at an angle within the range of 0° to 20°, and the centring surface is located in the centre by three rounded-off point surfaces.

4. The slotted according to claim 1, characterized in that the slot surfaces are vertical and parallel.

5. The slotted screw according to claim 1, characterized in that the screw head has a hemispherical further centring surface.

6. The slotted screw according to claim 1, characterized in that the slot seating surfaces are inclined outwards and downwards at an angle of 13°.

7. The slotted screw according to claim 1, characterized in that the slot seating surfaces are horizontal.

8. The slotted screw according to claim 1, characterized in that the slotted screw has a conical head underpart.

9. The slotted screw according to claim 1, characterized in that respective halves of the slot wall surfaces, with parallel reference to the longitudinal axis of the diametrical or radial slot, have an angle of 0° to 20°, preferably 3°, in order to facilitate the insertion of the centring surface and of the vertical screwdriving surfaces of the screwdriver/bit tip to be received into the diametrical or radial slot.

10. The slotted screw according to claim 2, characterized in that the slotted screw is designed in such a way that centring of the centring surface of the screwdriver/bit tip, to be received, in the hemispherical further centring surface of the screw head surface is made possible at a turning angle of 180°, and this without the deepest outer corners being superimposed on the screw head surface before entering the slot surfaces.

11. The slotted screw according to claim 1, characterized in that it is produced from ferrous metals, nonferrous metals or plastics.

12. The slotted screw according to claim 1, characterized in that it is produced as a magnetic unit for receiving or as a centring aid for screwdriver/bit tips of nonferrous metals to be received.

13. The slotted screw according to claim 1, characterized in that it is designed as a cheese head screw, countersunk screw, round head screw or raised countersunk head screw and has outer corner surfaces inclined upwards by 45°.

14. A tool, which is designed as a manual screwdriver or bit insert for a screwdriving apparatus, for use with a slotted screw according to claim 1, characterized in that a tip of the tool has vertical screwdriving surfaces, wherein the screwdriving surfaces are vertical or approximately vertical and are arranged in pairs parallel to one another or approximately parallel to one another, wherein the tip of the tool, furthermore, has slot seating surfaces, inclined outwards at an angle within a range of 0° to 20°, and a half-round and raised centring surface with its highest point, said centring surface being located in the centre by rounded-off corner surfaces, in such a way that centring of the screwdriver/bit tips in the slotted screw to be screwed in is ensured for insertion and for the start of and during the screwdriving operation.

15. The tool according to claim 14, characterized in that it is intended for use with a diametrically slotted screw and has two screwdriving surfaces parallel to one another or approximately parallel to one another and also two slot seating surfaces, inclined outwards at an angle within the range of 0° to 20°, and a half-round and raised centring surface located in the centre by two rounded-off corner surfaces.

16. The tool according to claim 14, characterized in that it is intended for use with a triple radially slotted screw and has triple pairs of screwdriving surfaces parallel to one another or approximately parallel to one another, wherein the pairs of screwdriving surfaces are each offset from one another by an angle of 120° relative to a vertical centring axis, wherein the tool, furthermore, has three slot seating surfaces, inclined outwards at an angle within the range of 0° to 20°, and the centring surface is located in the centre by three rounded-off corner surfaces.

17. The tool according to claim 14, characterized in that the two screwdriving surfaces are vertical and parallel.

18. The tool according to claim 14, characterized in that outer corners of the tip have sloping surfaces which are formed in such a way that they are adapted to an inclination angle of 45° of a conical head underpart of the slotted screw and of correspondingly designed diametrical or radial slots of cheese head screws, round head screws and raised countersunk head screws.

19. The tool according to claim 14, characterized in that the tip is produced as a magnetic unit for receiving or as a centring aid for a slotted screw to be screwed in and made of a ferrous metal.

20. The tool according to claim 14, characterized in that the tip on the screwdriving surfaces has anti-slip means for the force transmission and centring in the slot surfaces of the slotted screw to be screwed in.
